(19) United States
(12) Patent Application Publication
(10) Pub. No.: US 2022/0268910 A1
(43) Pub. Date: Aug. 25, 2022

(54) ULTRA-WIDEBAND INTEGRATED CIRCUIT (UWB IC) AND METHOD OF CALIBRATING A UWB PRODUCT THAT EMPLOYS THE UWB IC

(71) Applicant: Qorvo US, Inc., Greensboro, NC (US)

(72) Inventor: Jeff Clancy, Dublin (IE)

(21) Appl. No.: 17/182,517

(22) Filed: Feb. 23, 2021

(51) Int. Cl. G01S 13/02; G01S 5/14; G01S 13/76; G01S 13/00

(52) U.S. Cl. CPC G01S 13/0209; G01S 5/14; G01S 13/762; G01S 13/003

(57) ABSTRACT

Disclosed is an ultra-wideband integrated circuit having a transmitter, a receiver, and a non-volatile memory configured to store a time-of-flight between the transmitter and receiver. Also included is an interface configured to communicate with a processor configured to calculate the time-of-flight. Further included is a digital transceiver configured, in response to a loopback mode, to cause the transmitter to transmit a plurality of ultra-wideband frames directly to the receiver, measure a time-of-flight for each of the plurality of ultra-wideband frames received by the receiver and generate a data set for calculating the time-of-flight associated with each measured time-of-flight, send the data set to the processor, receive from the processor the time-of-flight calculated from the data set, and store the time-of-flight in the non-volatile memory.

### FIELD OF THE DISCLOSURE

The present disclosure relates to the field of wireless communication and more particular to time-of-flight calibration of ultra-wideband integrated circuits.

### BACKGROUND

Ultra-wideband technology is expected to be used widely for Real-Time-Location-Systems and various applications that require accurate wireless distance measurements. This is achieved by accurately estimating the time-of-flight between two or more ultra-wideband-based devices such as smart phones or cars and key fobs.

To achieve the best accuracy, any delays not related to the actual time-of-flight estimate must be considered when the time-of-flight is calculated. These delays consist of internal delays within an ultra-wideband integrated circuit and external delays introduced by external components such as printed circuit board traces, filters, and antennas. The external delays introduced by the external components are usually very consistent between printed circuit boards.

A largest variation in internal delay is introduced by the ultra-wideband integrated circuit alone. This variation in internal delay can be up to ±1 nanosecond, which equates to ±30 centimeters from one ultra-wideband integrated circuit to another ultra-wideband integrated circuit. A typical spread in internal delays from ˜5000 devices is shown in FIG. 1.

To remove this variation, ultra-wideband product manufacturers perform what is called antenna delay calibration as part of the end-of-line testing for ultra-wideband-based products such as smart phones. This antenna delay calibration is time-consuming and hence is expensive to perform. Thus, there is a need for an ultra-wideband integrated circuit and calibration method that provides facile and inexpensive calibration of ultra-wideband-based products that utilize ultra-wideband integrated circuits.

### SUMMARY

Disclosed is an ultra-wideband integrated circuit having a transmitter, a receiver, and a non-volatile memory configured to store a time-of-flight between the transmitter and receiver. Also included is an interface configured to communicate with a processor configured to calculate the time-of-flight. Further included is a digital transceiver configured, in response to a loopback mode, to cause the transmitter to transmit a plurality of ultra-wideband frames directly to the receiver, measure a time-of-flight for each of the plurality of ultra-wideband frames received by the receiver, and generate a data set for calculating the time-of-flight associated with each measured time-of-flight, send the data set to the processor, receive from the processor the time-of-flight calculated from the data set, and store the time-of-flight in the non-volatile memory.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a graph of internal delay spread for an ultra-wideband integrated circuit employed in ultra-wideband-based products.

FIG. 2 is a block diagram of an ultra-wideband integrated circuit that is structured in accordance with the present disclosure.

FIG. 3 is a flowchart for determining a time-of-flight with the ultra-wideband integrated circuit in a loopback mode with a transmitter and receiver of the ultra-wideband integrated circuit coupled together.

FIG. 4 is a flowchart of an ultra-wideband calibration process for an ultra-wideband-based product incorporating the ultra-wideband integrated circuit of FIG. 2.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

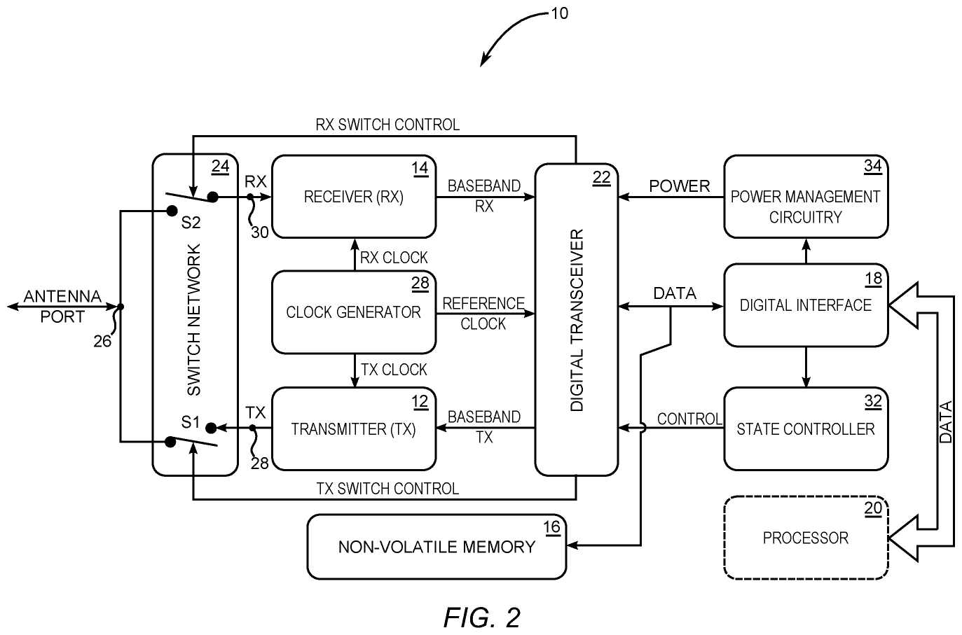

FIG. 2 is a block diagram of an ultra-wideband integrated circuit 10 having a transmitter 12, a receiver 14, and a non-volatile memory 16 configured to store a time-of-flight between the transmitter 12 and the receiver 14. The transmitter 12 typically up-converts baseband ultra-wideband pulses to a carrier generated by a frequency synthesizer, wherein the carrier is centered on a desired one of several ultra-wideband channels. In a transmission mode, the carrier is modulated and amplified before transmission from an external antenna (not shown). The receiver 14 typically includes an RF front-end that amplifies received ultra-wideband frames by way of a low-noise amplifier before down-converting the ultra-wideband frames directly to baseband.

A digital interface 18 is configured to communicate data between the non-volatile memory 16 and a processor 20. The processor 20 is configured to receive a data set passed from the digital interface 18 and calculate the time-of-flight. The processor 20 depicted in dashed line may be an external host processor or be integrated into the ultra-wideband integrated circuit 10.

Further included in the ultra-wideband integrated circuit 10 is a digital transceiver 22 that is configured, in response to a loopback mode, to cause the transmitter 12 to transmit a plurality of ultra-wideband frames directly to the receiver 14. In the exemplary embodiment of FIG. 2, a switch network 24 typically used to alternately and selectively couple the transmitter 12 and the receiver 14 to an antenna port 26 is repurposed to couple the transmitter 12 directly to the receiver in a loopback mode. For example, during a transmit mode, a transmit switch S1 coupled between the transmitter 12 and the antenna port 26 is closed by the digital transceiver 22 and a receive switch S2 is opened by the digital transceiver 22. In contrast, during a receive mode, the transmit switch S1 is opened by the digital transceiver 22 and the receive switch S2 is closed by the digital transceiver. However, during the loopback mode, the transmit switch S1 and the receive switch S2 are both closed by the digital transceiver to create a direct path between an output terminal 28 of the transmitter 12 and an input terminal 30 of the receiver 14.

In this regard, the digital transceiver 22 is further configured to measure a time-of-flight for each of the plurality of ultra-wideband frames received by the receiver 14 and generate the data set for calculating the time-of-flight associated with each measured time-of-flight. The digital transceiver 22 is also configured to send the data set to the processor 20, receive from the processor 20 the time-of-flight calculated from the data set, and store the time-of-flight in the non-volatile memory 16.

During transmit operation of the digital transceiver 22 a transmit pulse train is generated by applying digitally encoded transmit data to an analog pulse generator. The pulse train is up-converted by a transmitter block. During receive operation, an ultra-wideband signal is downconverted by a receiver block. Typically, the ultra-wideband signal is demodulated and the resulting received ultra-wideband data is made available to a host processor, which may be processor 20. The digital transceiver also uses the downconverted baseband signal to measure the time-of-flight of an incoming ultra-wideband frame.

The exemplary embodiment of the ultra-wideband integrated circuit of FIG. 2 further includes a clock generator 28 that is configured to receive a reference frequency that is used by integrated phase-locked loop frequency synthesizers to generate frequencies to run an internal system clock and to generate RF carrier signals used by the transmitter 12 and the receiver 14 for up/down frequency conversions. For example, the clock generator 28 generates a receiver (RX) clock signal used by the receiver 14, a transmit (TX) clock signal used by the transmitter 12, and a reference clock signal used by the digital transceiver 22.

A state controller 32 is coupled between the digital interface 18 and the digital transceiver 22. The state controller 32 is configured to orchestrate actions taken by the digital transceiver 22 by way of a control signal. For example, the state controller 32 ensures that the digital transceiver 22 closes the transmit switch S1 and opens the receive switch S2 when the ultra-wideband integrated circuit 10 is operating in the transmit mode. In contrast, the state controller 32 also ensures that the digital transceiver 22 opens the transmit switch S1 and closes the receive switch S2 when the ultra-wideband transceiver 10 is operating in the receive mode and ensures that the digital transceiver closes both the transmit switch S1 and the receive switch S2 when the ultra-wideband integrated circuit is operating in the loopback mode. The state controller 32 may be a digital logic state machine realized in either a field programmable array or physical logic gates.

Power management circuitry 34 provides and manages power for the ultra-wideband integrated circuit 10. The power management circuitry 34 typically includes voltage converters and regulators.

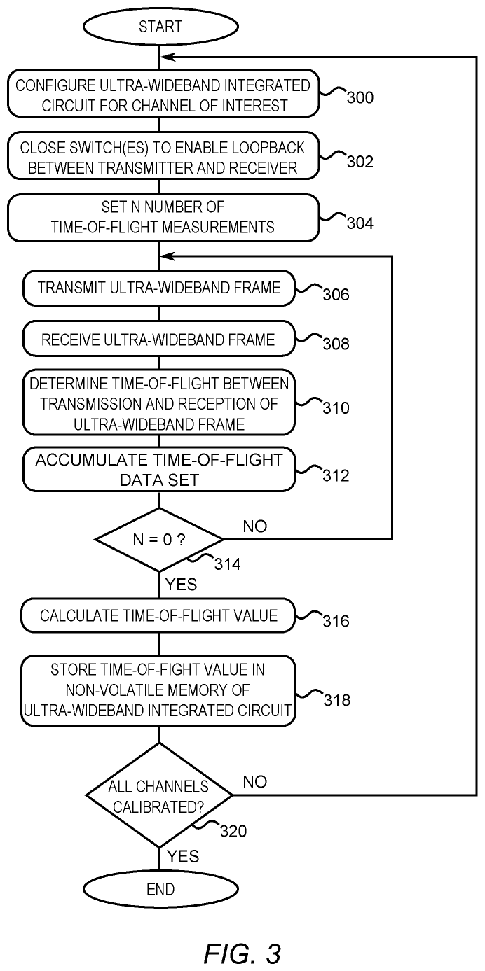

FIG. 3 is a flowchart for determining a time-of-flight with the ultra-wideband integrated circuit 10 in a loopback mode with a transmitter 12 and receiver 14 of the ultra-wideband integrated circuit 10 coupled together. The process begins with configuring the ultra-wideband integrated circuit 10 for a channel of interest (step 300). Next, the transmit switch S1 and the receiver switch S2 are both closed by the digital transceiver 22 to enable loopback between the transmitter 12 and the receiver 14 (step 302). A variable is set to countdown an N number time-of-flight measurements (step 304). It is to be understood that step 302 and step 304 may be swapped. Next, the transmitter 12 transmits an ultra-wideband frame (step 306) and the receiver 14 receives the ultra-wideband frame (step 308). The digital transceiver 22 then determines a time-of-flight between transmission and reception of the ultra-wideband frame (step 310). The determined time-of-flight is accumulated in time-of-flight data set (step 312).

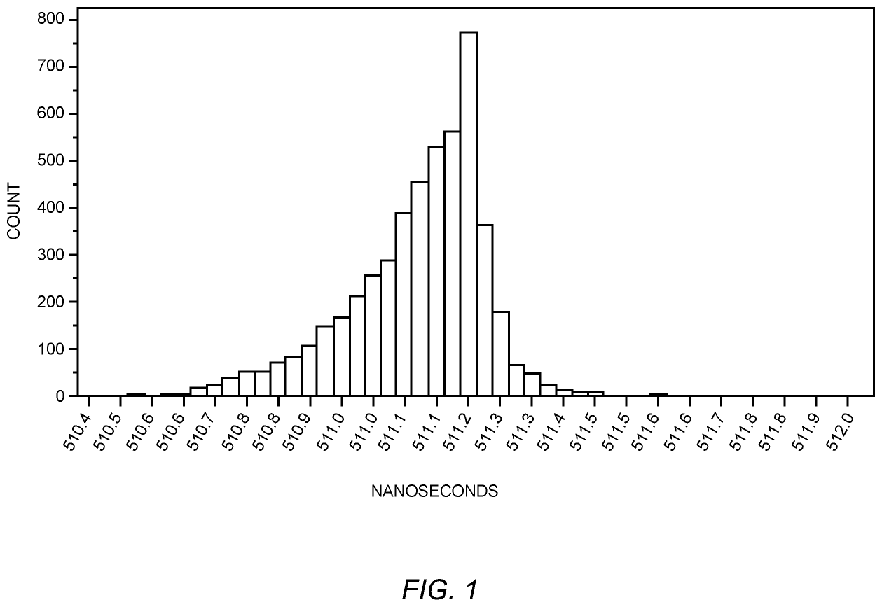

A decision is made regarding N number of time-of-flight measurements have been completed (step 314). If the N number of time-of-flight measurements have not been completed, time-of-flight measurements continues. In contrast, if the N number of time-of-flight measurements have been completed, the processor 20 (FIG. 1) calculates a time-of-flight from the time-of-flight data set (step 316). In some embodiments, the processor 20 is a host computer that is external to the ultra-wideband integrated circuit 10 (FIG. 1). In other embodiments, the processor is integrated within the ultra-wideband integrated circuit 10.

A digital value corresponding to the time-of-flight for the channel of interest is stored in the non-volatile memory 16 (step 318). A decision is then made regarding whether all channels have been calibrated with an time-of-flight stored in the non-volatile memory 16 (step 320). If so, the process is ended, else the process starts again with configuring the ultra-wideband integrated circuit for the next channel of interest (step 300).

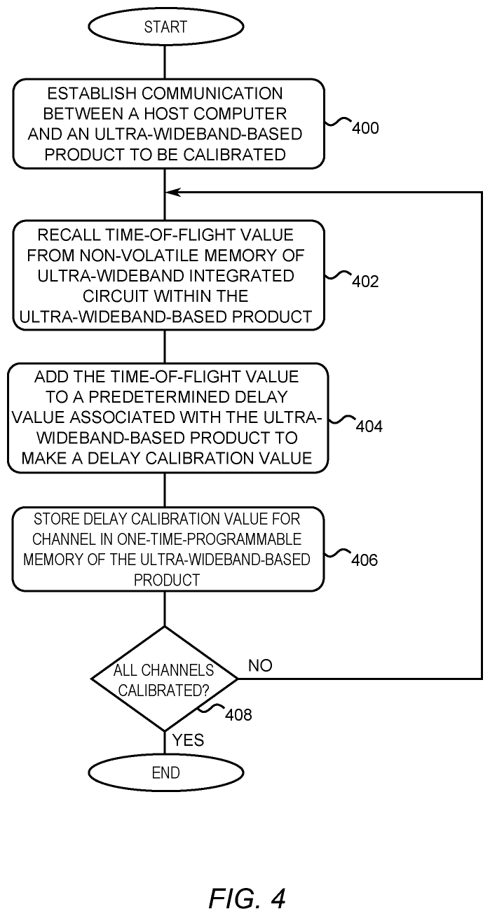

FIG. 4 is a flowchart of an ultra-wideband calibration process for an ultra-wideband-based product incorporating the ultra-wideband integrated circuit 10 depicted in FIG. 2. This method according to the present disclosure eliminates the antenna delay calibration typically necessary at back-end-of-line calibration of the ultra-wideband-based product incorporating the ultra-wideband integrated circuit 10. The method starts by establishing communication between a host computer and an ultra-wideband-based product to be calibrated (step 400). Then the value corresponding to the time-of-flight for a channel to be calibrated is recalled from the non-volatile memory 16 of the ultra-wideband integrated circuit 10 within the ultra-wideband-based product (step 402). Next, the host computer adds the value corresponding to the time-of-flight for the channel to be calibrated to a predetermined delay value associated with the ultra-wideband-based product (step 404). The host computer then stores the predetermined delay value for the channel in a one-time-programmable memory of the ultra-wideband-based product (step 406). The host computer then decides if all channels have been calibrated with a time-of-flight stored in the one-time-programmable method (step 408). If so, the process is ended, else the host computer recalls from the non-volatile memory 16 of the ultra-wideband integrated circuit 10 the value corresponding to the time-of-flight for the next channel to be calibrated (step 402).

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. An ultra-wideband integrated circuit comprising:
a transmitter;
a receiver;
a non-volatile memory configured to store time-of-flight corresponding to loopback delays between the transmitter and receiver;
an interface configured to communicate with a processor configured to calculate the time-of-flight; and
a digital transceiver configured, in response to a loopback mode, to:
2cause the transmitter to transmit a plurality of ultra-wideband frames directly to the receiver;
determine a time-of-flight for each of the plurality of ultra-wideband frames received by the receiver;
generate a data set for calculating a time-of-flight value associated with each determined time-of-flight;
send the data set to the processor;
receive from the processor the time-of-flight value calculated from the data set; and
store the time-of-flight value in the non-volatile memory.

2. The ultra-wideband integrated circuit of claim 1 wherein the data set is a plurality of time-of-flight measurements generated from an accumulation of each time-of-flight determined for each of the plurality of ultra-wideband frames received by the receiver.

3. The ultra-wideband integrated circuit of claim 1 wherein the data set is a summation of each time-of-flight determined and a numerical value representing the number of time-of-flights determined.

4. The ultra-wideband integrated circuit of claim 1 wherein the processor is external to the ultra-wideband integrated circuit.

5. The ultra-wideband integrated circuit of claim 1 wherein the processor is integrated within the ultra-wideband integrated circuit.

6. A method of calibrating an ultra-wideband integrated circuit having a transmitter, a receiver, and at least one switch configured to selectively couple the transmitter to the receiver in a loopback mode, a non-volatile memory configured to store a time-of-flight corresponding to loopback delays between the transmitter and receiver, and a digital transceiver configured, in response to a loopback mode, to execute a method comprising:
causing the transmitter to transmit a plurality of ultra-wideband frames directly to the receiver;
determining a time-of-flight for each of the plurality of ultra-wideband frames received by the receiver;
generating a data set for calculating a time-of-flight value associated with each determined time-of-flight;
sending the data set to a processor;
receiving from the processor the time-of-flight value calculated from the data set; and
storing the time-of-flight value in the non-volatile memory.

7. The method of calibrating the ultra-wideband integrated circuit of claim 6 wherein the data set is a plurality of time-of-flight measurements generated from an accumulation of each time-of-flight determined for each of the plurality of ultra-wideband frames received by the receiver.

8. The method of calibrating the ultra-wideband integrated circuit of claim 6 wherein the data set is a summation of each time-of-flight determined and a numerical value representing the number of time-of-flights determined.

9. The method of calibrating the ultra-wideband integrated circuit of claim 6 wherein the processor is external to the ultra-wideband integrated circuit.

10. The method of calibrating the ultra-wideband integrated circuit of claim 6 wherein the processor is integrated within the ultra-wideband integrated circuit.

11. A method of calibrating an ultra-wideband-based product comprising an ultra-wideband integrated circuit having a transmitter, a receiver, and a non-volatile memory configured to store a time-of-flight value corresponding to loopback delays between the transmitter and receiver, the method comprising:
recalling by way of a host computer the time-of-flight value from the non-volatile memory;
adding by way of the host computer the time-of-flight value to a predetermined delay value associated with the ultra-wideband-based product to generate a delay calibration value; and
storing the delay calibration value in a memory of the ultra-wideband-based product.

12. The method of calibrating the ultra-wideband-based product of claim 11 wherein the memory of the ultra-wideband based product is a one-time-programmable memory.

13. The method of calibrating the ultra-wideband-based product of claim 11 wherein the ultra-wideband integrated circuit comprises an interface configured to communicate with the host computer.

14. The method of calibrating the ultra-wideband-based product of claim 13 wherein the ultra-wideband integrated circuit further comprises a digital transceiver configured, in response to a loopback mode, to execute a method comprising:
causing the transmitter to transmit a plurality of ultra-wideband frames directly to the receiver;
determining a time-of-flight for each of the plurality of ultra-wideband frames received by the receiver;
generating a data set for calculating a time-of-flight value associated with each determined time-of-flight;
sending the data set to a processor;
receiving from the processor the time-of-flight value calculated from the data set; and
storing the time-of-flight value in the non-volatile memory.

15. The method of calibrating the ultra-wideband-based product of claim 14 wherein the data set is a plurality of time-of-flight measurements generated from an accumulation of each time-of-flight determined for each of the plurality of ultra-wideband frames received by the receiver.

16. The method of calibrating the ultra-wideband-based product of claim 14 wherein the data set is a summation of each time-of-flight determined and a numerical value representing the number of time-of-flights determined.

17. The method of calibrating the ultra-wideband-based product of claim 14 wherein the processor is external to the ultra-wideband integrated circuit.

18. The method of calibrating the ultra-wideband-based product of claim 14 wherein the processor is integrated within the ultra-wideband integrated circuit.
